(19) United States
(12) Patent Application Publication
(10) Pub. No.: US 2005/0289050 A1
(43) Pub. Date: Dec. 29, 2005

(54) Automated marketplace presentation and purchasing service for a data computing device

(76) Inventors: Raja P. Narayanan, Ladera Ranch, CA (US); Robert R. Granadino, Pasadena, CA (US); Kevin J. Johnson, Lake Forest, CA (US); Kimihiro Yoshino, Irvine, CA (US); Shigeyoshi Shimotsuji, Aliso Viejo, CA (US); Jeffrey P. Clark, Irvine, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/881,035

(22) Filed: Jun. 29, 2004

(51) Int. Cl. G06F 17/60

(52) U.S. Cl. 705/40

(57) ABSTRACT

One embodiment of the invention relates to a method for establishing network connectivity by a data computing device in order to download and store a catalog. The catalog includes information identifying consumables available for purchase within a marketplace. The storage of the catalog within memory of the data computing device enables subsequent review of the marketplace without continued network connectivity.

### FIELD

Embodiments of the invention generally relate to an automated marketplace presentation and purchasing service used by data computing devices.

### GENERAL BACKGROUND

Over the past decade, there has been rapid growth in electronic commerce (e-commerce), namely the purchase of goods or services over a worldwide network of computers commonly referred to as the “Internet”. For instance, the Internet has enabled consumers to purchase tangible goods supplied by a wide variety of vendors such as computers and other types of data computing devices.

The current relationship between consumers and data computing device vendors is strictly a buyer/seller relationship. Once a purchase is completed, the consumer owns the data computing device and the vendor has no further involvement with the consumer unless the data computing device experiences problems during the warranty period. This lack of continued involvement is unfavorable to both consumers and vendors.

As an example, consumers tend to purchase a large number of consumables after obtaining their data computing devices. Some of these consumables include Internet connectivity services, data backup services, software, content (e.g., audio files, video files, etc.), and the like. Given the fact that most consumers lack a technical background, many consumers often become confused as to which consumables to purchase when faced with compatibility or interconnectivity issues. This confusion may discourage some consumers from purchasing various consumables and cause some consumers to experience a lesser degree of product satisfaction.

Moreover, in order to purchase a consumable at an exceptional overall value over the Internet, consumers normally (i) visit a large number of websites or (ii) conduct a search using an Internet search engine. While the second option may reduce the amount of time and energy needed to locate consumables at exceptional values, both options fail to fully provide a downloadable, real-time presentation of the marketplace for the consumable and to encourage competition among the vendors of that consumable.

### BRIEF DESCRIPTION OF THE DRAWINGS

Features and advantages of embodiments of the invention will become apparent from the following detailed description in which:

FIG. 1 is an exemplary embodiment of a system implemented with an automated marketplace presentation and purchasing service.

FIG. 2 is an exemplary block diagram of the software architecture of the automated marketplace presentation and purchasing service within the system of FIG. 1.

FIG. 3 is a perspective view of the data computing device of FIG. 1 illustrated as a portable computer and bundled with selected services associated with the automated marketplace presentation and purchasing service.

FIG. 4 is an exemplary flowchart illustrating the registration operations of the data computing device.

FIG. 5 is an exemplary display screen layout featuring a registration display page.

FIG. 6A is an exemplary display screen layout featuring a first display page of an embodiment of an downloaded catalog.

FIG. 6B is an exemplary display screen layout featuring a second display page of the embodiment of the downloaded catalog.

### DETAILED DESCRIPTION

Embodiments of the invention set forth in the following detailed description generally relate to an automated marketplace presentation and purchasing service used by a data computing device. This service enables consumers to purchase consumables made available by a provider of a marketplace for consumables. For example, the provider may be a data computing device vendor or a partner of the data computing device vendor. The purchases may be paid in full or on a subscription or pay-as-you-go basis, both of which require periodic payments.

During use, the data computing device may be adapted to initiate an inquiry perceived by its consumer to determine whether a particular consumable, not currently owned or used by the consumer, is desired. The frequency of the inquiry may be periodic in nature or based on the occurrence of an event (e.g., power-up of the data computing device, an action by the consumer, etc.). As an illustrative example, a consumer using his data computing device at an off-site location (e.g., airport, courtroom, hotel, etc.) without any Internet connection may be prompted via an inquiry as to whether he would like to have temporary access to the Internet while at the off-site location. The inquiry may be any event capable of being perceived by the consumer such as a pop-up window, an audible sound or a more subtle event such as a flashing icon or an alert notification similar to those alerts that advise consumers of operating system updates and/or software patches.

In the following description, certain terminology is used to describe various features of one or more embodiments of the invention. As an example, an “interconnect” is generally defined as any medium or a collection of mediums that is capable of transferring information from one location to another. Examples of an interconnect may include, but are not limited or restricted to one or more electrical wires, cable, optical fiber, bus traces, or air when the data computing device (defined below) is deployed with a wireless transmitter and/or receiver.

A “consumable” is any good and/or service offered by one or more vendors. Examples of a consumable include, but are not limited or restricted to a peripheral, software, content (e.g., audio file, video file, etc.), an Internet connectivity service, a data backup service, a content download service, and the like. A “component” is hardware logic, software or firmware.

“Software” is generally defined as one or more instructions that when executed, cause the data computing device to perform a specific function or operation. Stored in machine-readable medium, these instructions may be a series of instructions or may take the form of an application program, a routine, an applet, or the like. Examples of machine-readable medium, which is any medium that can store and transfer information, include an interconnect (described above), an electronic circuit, a semiconductor memory device (non-volatile or volatile), a data storage disk (e.g., mechanical or optical hard drive), or any portable storage media such as a diskette, a disc, tape, card and the like.

In addition, a “vendor” is generally defined as a person or company who is able to provide a consumable to a consumer. Examples of vendors include, but are not limited or restricted to aggregators, suppliers, content providers as well as providers of other types of consumables.

An “aggregator” is a type of vendor who has established business relationships to receive one or more consumables from suppliers (e.g., manufacturers, distributors, retailers, wholesalers, etc.). Normally, this enables aggregators to provide consumables to consumers at a better overall value than if the consumables were purchased separately.

A “content provider” is a type of vendor that owns or is authorized to distribute content (e.g., audio files, video files, etc.). Examples of content providers may include, for example, a movie studio or record company as well as a content distributor such as Netflix.com, Inc. of Las Gatos, Calif. (NETFLIX®) or Apple Computer, Inc. of Cupertino, Calif. (ITUNES®).

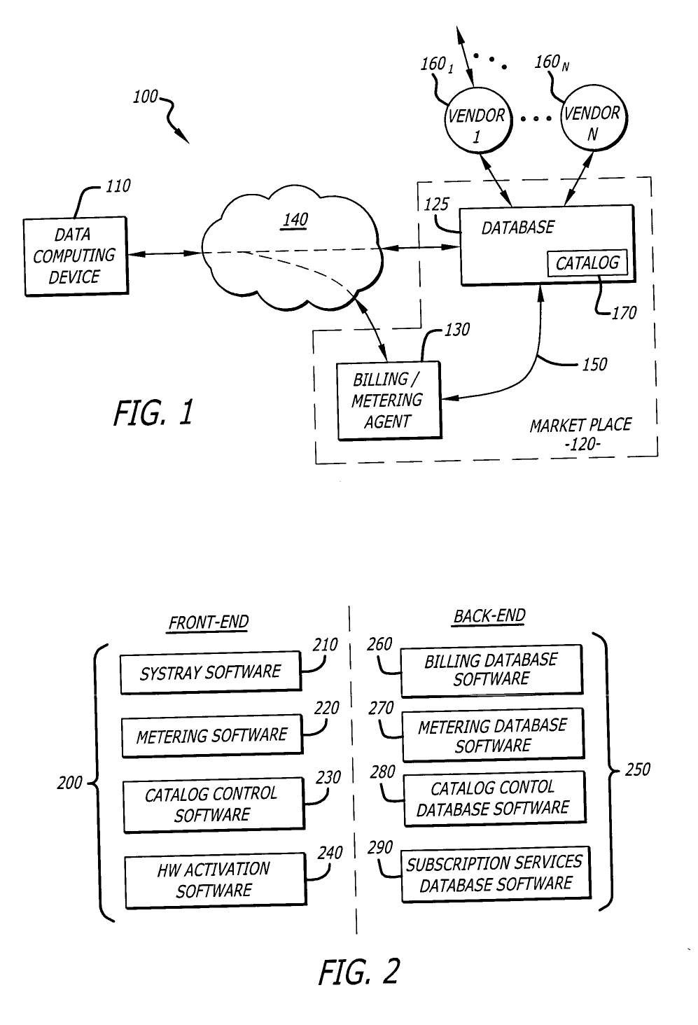

Referring to FIG. 1, an exemplary embodiment of a system 100 implemented with an automated marketplace presentation and purchasing service is shown. System 100 comprises a data computing device 110 in communication with a database 125 and billing/metering agent 130 over a first interconnect 140. Collectively, database 125 and billing/metering agent 130 operate to form a marketplace 120 for one or more consumables and may be in communication over first interconnect 140, or perhaps via a second, dedicated interconnect 150 as shown. As an optional feature, some or all of the communications between these system devices are secured using secure socket layer (SSL) or another type of cryptographic communication scheme.

As shown, data computing device 110 is an electronic product with network connectivity. Data computing device 110 is adapted to receive downloaded information summarizing those consumables that are available within the marketplace 120 formed by database 125 and billing/metering agent 130. The summarized downloaded information is referred to as a “downloaded catalog”. Illustrative examples of a “data computing device” include, but are not limited or restricted to a computer (e.g., laptop, desktop, portable, tablet PC, server, etc.), an electronic organizer, a personal digital assistant (PDA), a cellular telephone, an alphanumeric pager, a set-top box, a television, and the like. For clarity sake, however, data computing device 110 is illustrated herein as a laptop computer.

According to one embodiment of the invention, database 125 is configured to store account information associated with each consumer. This account information includes one or more of the following: name of the consumer; billing address; credit card number and expiration date; debit card number and personal identification number (PIN); email address; a registered, unique login name; and a password chosen by the consumer.

In addition, database 125 is a vendor-managed database that aggregates data concerning consumables offered by one or more vendors 160₁-160_{N}, where N≧1. This data aggregation is used to produce a catalog 170 that is stored in persistent memory of database 125. Updated on a real-time basis in response to consumables being newly offered or discontinued by vendors 160₁-160_{N}, catalog 170 includes a listing of consumables available for purchase within the marketplace 120. Each consumable is identified by one or more of the following parameters: (i) cost of the consumable; (ii) type of consumable; (iii) description of (or specifications for) the consumable; (iv) identity of the vendor providing the consumable and the like.

Periodically, some or all of the information stored as catalog 170 is downloaded to data computing device 110 and subsequently stored therein. This “downloaded catalog” provides the consumer with an updated listing of consumables available for purchase. It is contemplated that the listing may exclude certain consumables offered by various vendors which are deemed to be of a lesser overall value than those placed in catalog 170.

As a first illustrative embodiment, catalog 170 may include Internet connectivity service packages aggregated by vendor 160₁ from different Internet Service Providers (ISPs). Collectively, these ISPs would be able to offer consumers complete Internet connectivity independent of the location of data computing device 110. More specifically, data computing device 110 may receive substantially uninterrupted Internet access from multiple ISPs, depending on its location.

As an example, when data computing device 110 is located at a first location (e.g., workplace, residence), Internet connectivity would be provided by a first ISP over a first type of interconnect. However, at a second location (e.g., airport, restaurant, hotel, park, etc.), Internet connectivity is provided by a second interconnect supplied by a second ISP.

Alternatively, as another example, catalog 170 may include Internet connectivity service packages provided by a vendor 160₁, . . . , or 160_{N}. Each vendor 160₁, . . . , or 160_{N} would be chosen to supply a different type of Internet connectivity. For this embodiment, catalog 170 would enable the consumer to subscribe to Direct Subscriber Line “DSL” Internet services provided by vendor 160₁. Likewise, catalog 170 would enable the consumer to subscribe to cable-modem Internet services, dial-up Internet services or wireless Internet services separately provided by vendors 160₂-160₄, respectively.

Alternatively, as yet another example, catalog 170 may include Internet connectivity service packages from each vendor (ISP) 160₁-160_{N}. Each of these Internet connectivity service packages is designed to support any Internet connectivity type selected by the consumer.

In order to enable a purchase of network connectivity services, data computing device 100 establishes limited network connectivity with a public network (e.g., Internet) for only a predetermined period of time. Such limited connectivity occurs in response to a specific event (e.g., initial power-up of data computing device 100, every power-up of data computing device 100, etc.). This allows a consumer to conduct a real-time purchase an Internet connectivity service package.

Although not shown, it is also contemplated that data computing device 100 may be implemented with components to detect and process incoming wireless signals (e.g., beacons). Upon detection, data computing device 100 determines whether it currently supports wireless network connectivity. If not, data computing device 100 produces an inquiry to invite the consumer to purchase wireless network connectivity for a limited time (e.g., by minute, hour or day) or for a longer duration.

As a second illustrative embodiment, catalog 170 may include content download services. Herein, multiple vendors 160₁-160_{N} would offer digital content (e.g., video files, audio files, etc.) to be locally stored within data computing device 110. The digital content (or representation thereof) could be cryptographically protected and playback of the digital content would be detected and reported to the metering database software by metering software loaded on data computing device 110 as described below. The reporting may occur immediately or at a subsequent time when Internet access is available. It is contemplated, however, that the cryptographically protected content may be preloaded into data computing device 110 at manufacture in lieu of being downloaded from catalog 170.

As a third illustrative embodiment, catalog 170 may include specialized hardware configuration options. Herein, the consumer is able to temporarily (for a set time duration) or permanently activate hardware logic originally deployed within data computing device 110 in a deactivated state by selectively altering the downloaded catalog provide to data computing device 110. Activation of the hardware logic is performed to obtain additional functionality or improve performance of data computing device 110. Of course, it is contemplated that catalog 170 may identify any type of component adapted for selective activation, deactivation or upgrade by the consumer. For instance, catalog 170 may enable (i) hardware logic to be activated, deactivated or adapted with enhanced performance, (ii) new or upgrade software to be downloaded and the like.

As an example, data computing device 110 comprises a voice-over-IP component (e.g., VoIP coder/decoder “VoIP Codec,” VoIP echo cancellation unit, etc.) initially installed in a deactivated state. In response to selection of this VoIP activation entry within the downloaded catalog and receipt of payment, the downloaded catalog enables activation of the VoIP component. Continued use of the VoIP component is permitted, provided periodic payments subsequent to the initial payment are made. Hence, usage of hardware logic (e.g., VoIP component, etc.) is on a subscription basis. As another example, catalog 170 may enable a consumer to upgrade processor speed, memory sizing, bus speed, and other adjustable characteristics of hardware logic deployed within data computing device 110.

As further shown in FIG. 1, billing/metering agent 130 is a server configured to receive purchasing information from data computing device 110. The purchasing information may include a parameter that identifies the consumable purchased from the catalog. The purchasing information may further include metering information that comprises one or more parameters that are used to meter usage for billing purposes (e.g., number of times played, number of downloads, total time of usage, time of day, etc.).

Upon receiving metering information from data computing device 110, billing/metering agent 130 establishes communications with database 125 in order to notify and pay the vendor(s) 160₁, . . . , and/or 160_{N} supplying the purchased consumable. Such communications may be established over dedicated interconnect 150.

Referring now to FIG. 2, an exemplary block diagram of the software architecture of the automated marketplace presentation and purchasing service implemented with system 100 of FIG. 1 is shown. The software architecture can be categorized into two classes; namely, front-end software 200 and back-end software 250.

Front-end software 200 is software processed by the data computing device 110 of FIG. 1, which operates to provide consumers with a downloaded catalog being a substantial real-time representation of a marketplace for certain consumables. According to one embodiment of the invention, front-end software 200 comprises an optional SystemTray “Systray” software 210 represented by dashed lines, a metering software 220, a catalog control software 230 and a hardware activation software 240.

Back-end software 250 is software processed by database 125 and billing/metering agent 130 of FIG. 1 in order to produce a marketplace for certain consumables. According to one embodiment of the invention, back-end software 250 comprises billing database software 260, metering database software 270, catalog database software 280, and subscription services database software 290.

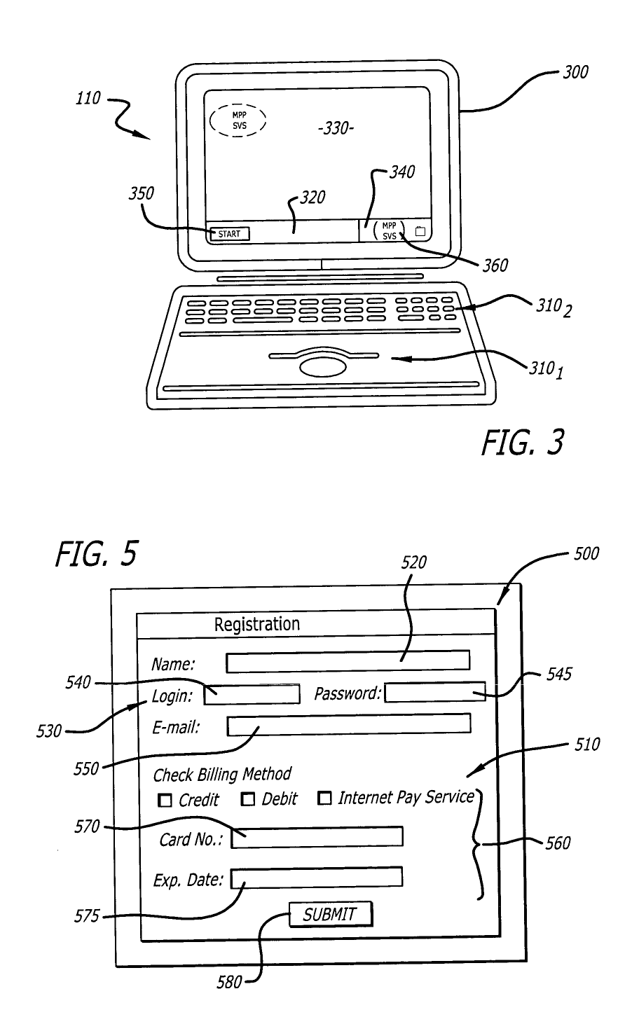

According to one embodiment of the invention, each time the data computing device is powered up, Systray software 210 installs catalog control software 230 into a registry, namely a place for keeping information regarding what software is present when the operating system of the data computing device is started. After installation, an icon representative of catalog control software 230 is placed into the Systray. A consumer can select the corresponding icon displayed on the Systray to launch catalog control software 230. Of course, other software installation techniques may be used besides Systray as described in FIG. 3.

Metering software 220 is used in order to monitor usage for a subscribed service and to report such usage to metering database software 270. As an illustrative example, metering software 220 can be used in order to count the number of audio or video downloads conducted by the data computing device and return the count value to metering database software 270 of back-end software 250. As another example, metering software 220 can be utilized to keep track of the amount of time incurred when conducting an activity (e.g., surfing the Internet) when billing is performed on per time basis.

Catalog control software 230 controls the display of the downloaded catalog and periodic updates of the downloaded catalog in response to changes in the catalog maintained by catalog database software 280. In addition, catalog control software 230 communicates with billing database software 260 when the consumer subscribes to or purchases a consumable.

In communication with back-end software 250, activation software 240 is responsible for activating hardware logic already installed within the data computing device but currently in an deactivated state. Examples of such hardware logic include, but are not limited or restricted to a VoIP component, processor, chipset, memory unit, input and/or output interface, and the like. The period of activation may vary, depending on the subscription period. After the subscription period has elapsed, the selected hardware logic is placed in its original deactivated state. This enables the user to adjust the functionality of the data computing device after purchase.

Back-end software 250 features billing database software 260 that is used to debit the consumer's credit card or financial accounts upon selection of certain consumables identified in the catalog. Billing database software 260 is also configured to distribute a portion of the payment received with the vendor or vendors who provided the purchased consumable to the consumer.

Subscription services database software 290 is used to acquire and store information concerning the consumer. For instance, subscription services database software 290 is used to obtain account information of registered consumers. This information is stored in database 125 of FIG. 1 and made available as needed.

Referring now to FIG. 3, a perspective view of data computing device 110 illustrated as a portable computer is shown. Data computing device 110 comprises a display 300 and one or more (M) input devices 310₁-310_{M} upon which information can be input into data computing device 110. For instance, as shown, data computing device 110 comprises a first input device 310₁, which can used to select consumables listed on a downloaded catalog. First input device 310₁ may be a cursor control device (e.g., mouse, trackball, touchpad, stylus). In addition, data computing device 110 may further comprise a second input device 310₂ such as a keyboard (as shown), a credit card reader or even a biometric input device.

As further shown in FIG. 3, display 300 illustrates a taskbar 320 positioned across the bottom of the display area 330 of display 300. Systray 340 is located on a right side of taskbar 320. Systray 340 includes a collection of small icons on the opposite side of the START Menu 350. Each of the icons represents software that has been automatically installed into the registry of the data computing device 110 during power-up.

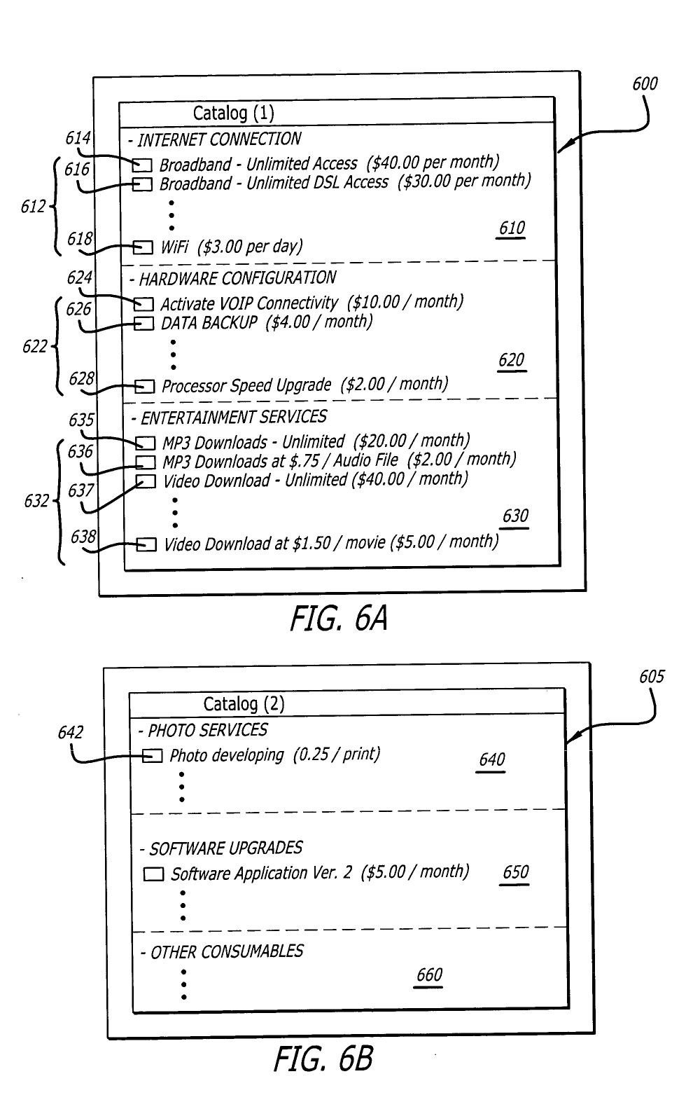

As an example, one of the icons (e.g., icon 360) may be used to launch the catalog control software of FIG. 2, which subsequently causes the display and/or updating of the downloaded catalog. When initially launched, the catalog control software causes the downloaded catalog to be displayed as shown in FIGS. 6A-6B. This allows the consumer to select additional consumables.

Alternatively, in lieu of placement of icon 360 in Systray 340, icon 360 may be displayed as a program icon in display area 330. When selected, the catalog control software is launched, which causes the downloaded catalog to be displayed and/or updated. Moreover, in lieu of placement of icon 360 within display area 330, the catalog control software may be launched using a menu-driven procedure. For instance, this may involve selection of START menu 350 and subsequent selection of a menu entry identifying the catalog control software as a program loaded within data computing device 110.

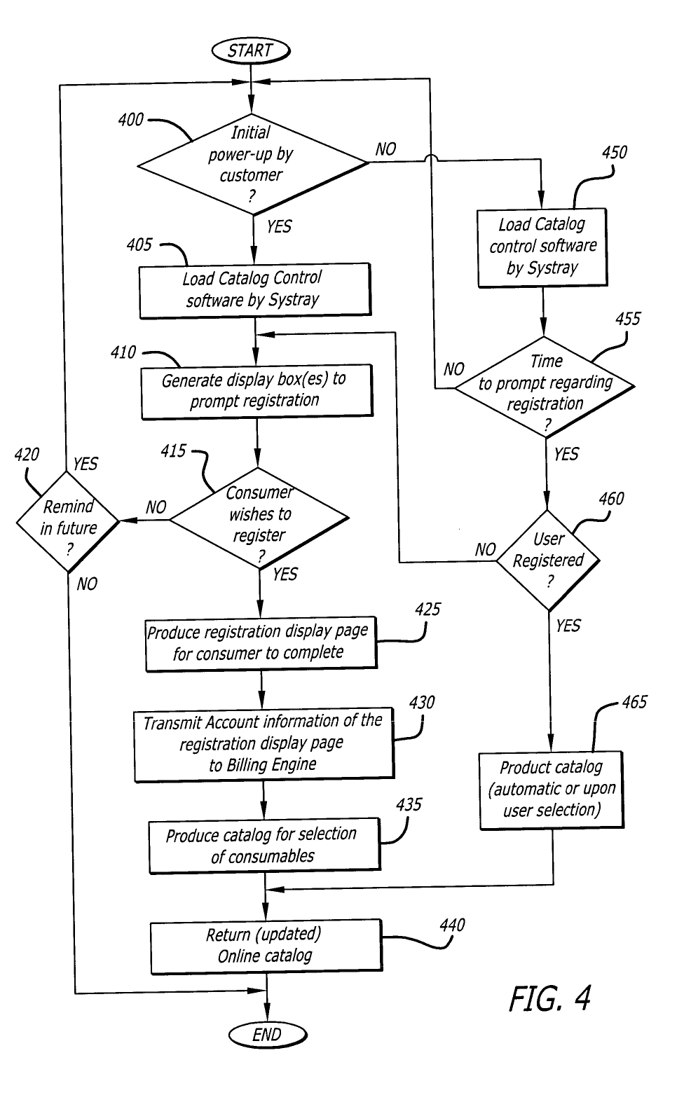

Referring now to FIG. 4, a flowchart illustrating an exemplary registration process encountered by a consumer during registration for membership in the automated marketplace presentation and purchasing service is shown. It is contemplated that other variations of the registration process may be conducted without departing from the spirit and scope of the invention.

At the initial power-up of the data computing device, the catalog control software is installed into the registry and a representative icon is displayed within the systray (blocks 400 and 405). In response to an event (e.g., consumer selects the icon, a prescribed period of time has elapsed, etc.), one or more display boxes are generated (block 410). The display box(es) may be organized to request the consumer to indicate the following: (i) whether he or she would like to register with the marketplace presentation and purchasing service referred to for ease as “MPP Services” (block 415) and (ii) if not, does the consumer wish to be reminded of such registration in the future (block 420).

In the event that the consumer wishes to register with MPP Services, a registration display page is displayed. Using an input device of the data computing device, the consumer enters his or her account information (block 425). Upon completion, the account information entered into the registration display page is transmitted to the billing engine being one or both of the database and the billing/metering agent (block 430). Such transmission may be accomplished over a communication pathway secured by secure socket layer (SSL) or another cryptographic scheme.

In response to receipt of the account information (and perhaps verification thereof), the current catalog is transmitted to and stored within the data computing device (blocks 435 and 440).

In response to subsequent power-up operations by the data computing device, the catalog control software is again installed into the registry and the representative icon is displayed within the systray (block 450). In response to an event, a determination is made if the consumer is registered with MPP Services (blocks 455 and 460). If the consumer is registered, the downloaded catalog is obtained by the data computing device (block 465). Otherwise, if the consumer is not registered, the registration process proceeds to block 410. In some configurations, pre-payment is required for consumption based on consumables ordered.

Referring now to FIG. 5, a display screen layout featuring a registration display page 500 is shown. Registration display page 500 may be accessed in any number of ways. For instance, a consumer can visit a website to register with MPP Services. According to another embodiment, upon initial power-up of the data computing device, a series of dialog box(es) are generated to prompt registration as described in FIG. 4. According to yet another embodiment, the catalog control software may be adapted to generate periodic pop-up advertisements requesting whether the consumer wishes to sign up for MPP Services.

Once registration is commenced, registration display page 500 is displayed. Registration display page 500 comprises a plurality of fields 510 that are adapted to receive information from an input device of data computing device 110. These fields 510 include a name field 520, a consumer identification field 530, an email address field 550 and billing information fields 560.

Herein, for this embodiment, name field 520 is adapted to receive alphanumeric characters forming the name of the consumer. Consumer identification field 530 comprises a first field 540 to receive as input a proposed login name and a second field 545 to receive as input a proposed password for the consumer. It is contemplated that multiple login name fields and/or password fields may be provided to detect a mistyped password and to prevent the consumer from being required to input information if the chosen login name is already being used.

As further shown in FIG. 5, email field 550 is adapted to receive alphanumeric characters representing an email address of the consumer. Billing information fields 560 comprise a first field 570 to identify the billing method selected by the consumer (credit, debit, Internet pay service) as well as a second field 575 including the credit card number and expiration date, debit card number, and the like.

Upon selection of a SUBMIT button 580 to denote completion of the registration process, the account information entered by the consumer is transmitted to the billing engine and stored in an appropriate database structure within database 125 of FIG. 1.

Referring now to FIGS. 6A-6B, a display screen layout featuring display pages of a first embodiment of the downloaded catalog is shown. One or more pages (e.g., first and/or second pages 600, 605) of the catalog comprise a listing of a plurality of consumables that can be purchased by the consumer. These consumables are categorized according to general functionality as shown, but may be categorized in other manners such as alphabetically, by cost, or by anticipated usage based on information previously provided by the consumer.

As shown for illustrative purposes, the downloaded catalog 170 is divided into five classifications; namely, Internet connectivity 610, hardware configuration 620 and entertainment services 630, photo services 640, software upgrades 650 and other consumables 660 not associated with data computing device 100 (e.g., televisions and other consumer electronics, travel services and any other type of consumable).

Internet connectivity 610 features a plurality of selection boxes 612 that, when selected, enable the user to select different types of network connectivity to be utilized by the data computing device. For example, upon selection of box 614, the consumer is provided unlimited and substantially uninterrupted Internet service for $40.00 per month after completing subsequent forms to select the user name (not shown). In addition, upon selection of box 616 or 618, the consumer is provided unlimited DSL connectivity at $30.00 per month and wireless connectivity (e.g., WiFi connectivity) at $3.00 per day. The prescribed dollar amount and time period for these services and other services may vary and are a design choice.

Hardware configuration 620 features a plurality of selection boxes 622 that, when selected, enable the user to select different hardware logic to activate in order to alter the functionality of the data computing device. For example, upon selection of box 624, the VoIP component is activated that enables the consumer to use the data computing device for VoIP telephonic communications for 10$ per month. As another example, upon selection of box 626 or 628, the consumer is provided daily data backup for a specified period at $4.00 per month and an upgrade in processor speed at $2.00 per month.

Entertainment services 630 feature a plurality of selection boxes 632 that, when selected, enable the user to select different content delivery services. For example, upon selection of boxes 635 and/or 636, the consumer is allowed unlimited downloads of audio files and/or video files for $20.00 & $40.00 per month, respectively. Moreover, upon selection of boxes 637 and 638, the consumer is provided a reduced rate per download upon payment of a nominal monthly fee. This service may be selected by those consumers who download a low number of audio files and/or video files per month.

Photo services 640 feature at least one selection box 642 that, when selected, enables the user to select a reduced photograph developing rate based on anticipated usage. For example, upon selection other boxes (not shown), the consumer is charged a flat rate of $0.25 per developed photograph. Other rates with monthly fees may be provided in order to obtain a reduced photograph development rate.

Software upgrades 650 feature at least one selection box 652 that, when selected, enable the user to purchase and receive downloaded copies of new or updated versions of software.

In the foregoing description, the invention is described with reference to specific exemplary embodiments thereof. It will, however, be evident that various modifications and changes may be made thereto without departing from the broader spirit and scope of the present invention as set forth in the appended claims. Therefore, the specification and drawings are accordingly to be regarded in an illustrative rather than in a restrictive sense.

1. A method comprising:
receiving a catalog by a data computing device, the catalog being information representative of a real-time summary of consumables available for purchase within a marketplace; and
storing the catalog within a memory of the data computing device to enable subsequent review of the catalog without continued network connectivity.

2. The method according to claim 1 further comprising establishing network connectivity by the data computing device when one of the consumables is selected for purchase.

3. The method according to claim 1 further comprising:
playback of preloaded digital content identified within the catalog.

4. The method according to claim 1 further comprising:
detecting and reporting playback of the preloaded digital content to a metering database software for billing purposes upon reestablishing network connectivity by the data computing device.

5. The method according to claim 1, wherein the review of the catalog is displaying of the catalog on a display of the data computing device.

6. The method according to claim 1, wherein prior to receiving the catalog, the method further comprises automatically downloading the catalog during power-up of the data computing device.

7. The method according to claim 1, wherein the marketplace includes an aggregator obtaining a plurality of consumables from one or more vendors, the plurality of consumables being greater in number than the consumables identified within the catalog.

8. The method according to claim 1, wherein the marketplace is formed by vendors chosen by a manufacturer of the data computing device.

9. The method according to claim 1 further comprising:
periodically initiating an inquiry as to whether a consumer using the data computing device is interested in purchasing one of the consumables.

10. The method according to claim 9, wherein the periodically initiating the inquiry comprises:
determining whether the data computing device is in an environment without network connectivity; and
displaying the inquiry on a display screen of the data computing device to inquire whether the consumer is interested in purchasing network connectivity.

11. The method according to claim 10, wherein the periodically initiating the inquiry further comprises:
displaying the catalog including a plurality of network connectivity service packages including a first network connectivity service package providing Internet connectivity independent of a location of the data computing device.

12. The method according to claim 1 further comprising:
periodically updating the catalog to account for changes in the consumables available for purchase.

13. The method according to claim 1 further comprising:
displaying the catalog including a plurality of hardware configuration options; and
activating hardware logic placed in a deactivated state within the data computing device when a service for activating the hardware logic is purchased by a consumer.

14. A method comprising:
storing a catalog on a data computing device; and
display of the catalog on the data computing device to enable a consumer using the data computing device to purchase consumables, the catalog comprises information identifying consumables available for purchase including at least one of (i) a first consumable that, when purchased, offering network connectivity and (ii) a second consumable that, when purchased, altering performance of a component already placed within the data computing device.

15. The method according to claim 14, wherein the altering of the performance of the component includes activating, deactivating or updating the component.

16. The method according to claim 14, wherein the downloading of the catalog is automatic during power-up of the data computing device.

17. The method according to claim 14, wherein the catalog represents a real-time summary of all consumables available for purchase within a marketplace formed by vendors on approval by a manufacturer of the data computing device.

18. The method according to claim 14 further comprising:
periodically initiating an inquiry as to whether a consumer using the data computing device is interested in purchasing one of the consumables available for purchase.

19. The method according to claim 18, wherein the periodically initiating the inquiry comprises:
determining whether the data computing device is in an environment without network connectivity; and
displaying the inquiry on a display screen of the data computing device to inquire whether the consumer is interested in purchasing a network connectivity service package offering substantially uninterrupted network connectivity for the data computing device.

20. The method according to claim 18, wherein the periodically initiating the inquiry comprises:
displaying the catalog including a plurality of components initially implemented within the data computing device in a deactivated state; and
activating the component within the data computing device when a service for activating the component is purchased by the consumer.

21. The method according to claim 14 further comprising:
transmitting purchasing information over a network to notify a vendor to provide at least one of the first and second consumables purchased.

22. A software stored within a machine-readable medium and executed by a processor, comprising:
metering software to monitor and report usage of a subscribed service; and
catalog control software to control (i) a display of a downloaded catalog including information identifying a plurality of consumables available for purchase and (ii) periodic updates of the downloaded catalog.

23. The software according to claim 22, wherein the metering software reports usage of the subscribed service to back-end software operating within a database that aggregates data concerning the plurality of consumables available for purchase.

24. The software according to claim 22, wherein the catalog control software further communicates with a billing database software in response to a purchase of one of the plurality of consumables.

25. The software according to claim 22 further comprising:
activation software to activate a component initially installed in a deactivated state within the data computing device.

26. The software according to claim 25, wherein the activation software to activate a Voice-Over-IP component.

27. The software according to claim 25, wherein the component is a memory unit.

28. The software according to claim 22 further comprising:
software to upgrade functionality of a component by increasing operational speed of the component.

29. The software according to claim 22 further comprising:
software to upgrade functionality of a component by increasing data storage capacity of the component.

30. A method comprising:
determining whether a data computing device is in an environment without network connectivity; and
displaying an inquiry on a display screen of the data computing device to inquire whether the consumer is interested in purchasing network connectivity.

31. A method comprising:
receiving a catalog by a data computing device, the catalog being information representative of a real-time summary of consumables available for purchase within a marketplace; and
providing limited network connectivity that restricts access to a public network but enables a consumer of the data computing device to purchase a network connectivity service package.

32. The method according to claim 31, wherein the network connectivity service package provides uninterrupted network connectivity over an interconnect.

33. The method according to claim 31, wherein the providing limited network connectivity is in response to an event occurring at the data computing device.

34. The method according to claim 33, wherein the event is a power-up operation conducted by the data computing device.

35. A method comprising:
storing a catalog on a data computing device, the catalog comprises information identifying digital content preloaded within memory of the data computing device and available for purchase;
displaying the catalog on the data computing device to enable a consumer using the data computing device to select and subsequently playback the digital content without network connectivity; and
reporting information regarding the purchase of the digital content to a billing engine upon establishing network connectivity by the data computing device.

36. The method according to claim 35, wherein the reporting of the information includes reporting of purchasing information immediately after selection of the digital content and before playback of the digital content.

37. The method according to claim 35, wherein the reporting of the information includes reporting of purchasing information after selection and playback of the digital content.

38. The method according to claim 35, wherein the digital content includes one of a video file and an audio file.
